(19) United States
(12) Patent Application Publication
(10) Pub. No.: US 2024/0273570 A1
(43) Pub. Date: Aug. 15, 2024

(54) BILL UPLOAD FOR PERSONALIZED OFFERS, PORTING, AND ACCOUNT INTEGRATION

(71) Applicant: DISH Wireless L.L.C., Littleton, CO (US)

(72) Inventors: Stephen Bender, Littleton, CO (US); James McCabe, Highlands Ranch, CO (US); John Lindmark, Denver, CO (US); Joel Huerta, Centennial, CO (US); Paul Ortolf, Littleton, CO (US)

(21) Appl. No.: 18/440,718

(22) Filed: Feb. 13, 2024

Related U.S. Application Data
(60) Provisional application No. 63/484,988, filed on Feb. 14, 2023.

(51) Int. Cl. G06Q 30/0241; G06Q 30/0601

(52) U.S. Cl. CPC G06Q 30/0248; G06Q 30/0611

(57) ABSTRACT

Aspects of the disclosed technology relate to analyzing and providing recommendations to a user based on an obtained bill or other document from a user. The bill or other document may be analyzed to create a customer profile. One or more recommendations can be provided to the user based on current billing plans which most closely tailor to the current usage of the user. Additionally, the user may switch to the new service plan automatically or semi-automatically based on streamlined processes, such as an eSIM or mailing of a new SIM card.

### CROSS REFERENCE TO RELATED APPLICATIONS

This application claims priority to U.S. Provisional Patent Application No. 63/484,988, filed on Feb. 14, 2023, the disclosure of which is incorporated by reference in its entirety for all purposes.

### BACKGROUND OF THE DISCLOSURE

The present disclosure generally relates to systems, methods, and program products for intake of new customers, and more particularly techniques for customizing offers based, in part, on a user's existing bill or other customer account document.

Customers complain about websites/applications being too complicated to find the information they need to switch wireless carriers (or other service provider) and the manual nature of entering their personal information. Customers may not believe or know that they are getting a better deal against their current carrier's bill. The current options require a customer to use a manual selection tool on a website, chat virtually with an agent, or call into a contact center. Each of these take unnecessary time and deter users from switching carriers.

Further, customizing offers to better align with a customer's current requires evaluation by customers of what is currently available in the marketplace, their credit score, customizable options, and other considerations.

Additionally, switching carriers and current processes in the marketplace create undue stress and digital fatigue for the modern consumer. To switch a service, the customer may be required to take a number of actions which are digital (e.g., through a website), manual (e.g., making a phone call), and physical (e.g., mailing a SIM card, verifying their identity, or looking up a device model). These all lead to friction when making a change from a current service provider.

Thus, there is a need for seamless options which require minimal effort on the part of a consumer to evaluate other offers at service providers, port his or her service and/or number, and enroll with a new service provider.

### BRIEF DESCRIPTION OF THE DRAWINGS

A further understanding of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a diagram of an example billing document in accordance with some embodiments of the disclosure.

FIG. 2 is a diagram of an example system for analyzing user needs for signing in accordance with some embodiments of the disclosure.

FIG. 3 is a diagram of an example offer on a user device in accordance with some embodiments of the disclosure.

FIG. 4 is a flow diagram of an exemplary method for signing up a new customer in accordance with some embodiments of the disclosure.

FIGS. 5A and 5B are a flow diagram of an exemplary method for signing up a new customer in accordance with some embodiments of the disclosure.

FIG. 6 is a flow diagram of exemplary system for use with some embodiments of the disclosure.

### BRIEF SUMMARY

Embodiments provide systems, methods, and computer readable media to simplify and provide streamlined processes to switch mobile or other service providers.

The digital property may include a website, a mobile app, and a kiosk. The digital file of the user's current bill may be a file type of one or more of the following an XML file, a PDF, a screenshot, and an image file. The digital file may be scanned for viruses. It may be determined that the digital file is free of viruses. It may also be determined that the digital file has one or more viruses and in response, an error message may be displayed to the user. In response to receiving the user identifier a credit check of the user may be run. In response to the user's credit score being below a threshold, the at least one offer may be altered. The user identifier may be one of a driver's license, a social security number, a passport, a national identification number, driver's license number, tax identification number, or digital credential. The extracted data may be one of an account number, phone number, user's name, address, zip code, current plan type, current carrier name, monthly bill total, VAS, phone module, phone type, and phone year. A fraud analysis related to the user may be performed.

A user account may be provisioned in response to passing the fraud analysis related to the user. The provisioned user account based at least in part on the at least one offer selected by the user. The method may include preparing activation of the provisioned user account based on key inputs from the user. Key inputs may be one of a user agreement, smart contract, or electronic contract. The customer profile may be cross-referenced with an internal customer profile database to determine if the user is an existing customer; and if the user is an existing customer, notifying the user.

The method may include obtaining device specific information, IP address, or location specific information related to the user; and generating a localized offer based on the device specific or location specific information. The at least one offer may be generated using generative artificial intelligence. The at least one offer may be interacted with by the user prior to offer selection.

Examples may include a client device. The client device may be utilized in conjunction with a server and a communications network enabling communication between the client device and the server. The client device may include a processor; and a computer-readable storage media storing computer-executable code that, when executed by the processor, causes the client media device to: receive a request from a user at a digital property; determine, by digital operator platform (DOP), that the user is a new customer; request, from the DOP, upload digital file of the user's current bill and a user identifier (e.g., the user's last four digits of their social security number (SSN)); receive, at the DOP, the digital file and a user identifier provided by the user; extracting data from the digital file; receive, at the DOP, the digital file and last four digits of the SSN; extract data from the digital file; generate a customer profile based on at least the extracted data and the user identifier, the customer profile containing information to analyze potential offers for a user; based on the customer profile, generate at least one offer to the user for new service; display the at least one offer to the user or configure the at least one offer to be displayed to the user; and receive an offer selection from the user and in response proceeding to checkout for the user.

Examples may include a digital operator platform. The digital operator platform may be configured to facilitate user offers and user enrollment. The digital operator platform may comprise a communication interface, configured to facilitate interaction between the digital operator platform and a user device, enabling receipt of a billing document and delivery of generated service offers to a user; a processing module, the processing module configured to analyze the billing document received from a user device and generate a customer profile; a recommendation engine within the digital operator platform to generate service offers based on the generated customer profile; an artificial intelligence module coupled with the recommendation engine configured to enhance the generated service offers; and a verification module configured to verify the accuracy of information contained in the billing document and to confirm an identity of the user. The digital operator platform may be configured to enroll the user in a selected offer from the generated service offers and initialize the selected service offer.

### DETAILED DESCRIPTION OF THE DISCLOSURE

The following Detailed Description is merely exemplary in nature and is not intended to limit the scope of the present disclosure or the application and uses of the teachings of the present disclosure.

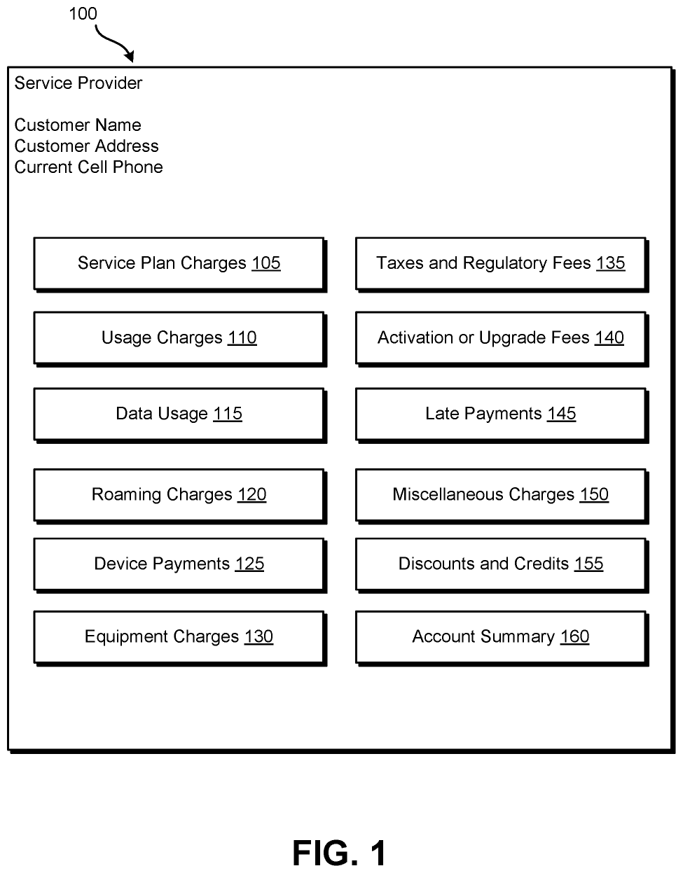

FIG. 1 illustrates a document 100. Document 100 may be a document for services, presenting various sections each delineating different aspects of charged services and fees. In some embodiments, the document may be a mobile phone bill. In some embodiments, the digital property may be a separate type of bill or invoice, such as a cable bill, internet service provider bill, or combined bill. Document 100 may be in an electronic format (e.g., a picture, XML, HTML, or a PDF) or in a paper format. If document 100 is in a paper format, it may be turned into a digital or electronic format by a user through using a smartphone camera, scanner, or other image capture device to enable the digital property to be analyzed as further described herein. Document 100 may contain information related to a user, such as a service provider name, a customer name, a customer address, current cell phone number or other identifier. Additional information may be included in document 100 as discussed below.

Illustrated in FIG. 1 are the various aspects of the document 100, including service plan charges 105, usage charges 110, data usage 115, roaming charges 120, device payments 125, equipment charges 130, taxes and regulatory fees 135, activation or upgrade fees 140, late payment fees 145, Miscellaneous charges 150, and discounts and credits 155. Service plan charges 105 may include the base costs for talk time, texts, and data under a standard service agreement. Usage charges 110 may represent additional costs for usage exceeding standard plan limits. Data Usage 115 may include data consumed, including overage data. Roaming charges 120 may indicate charges for services used outside the standard coverage area. Device payments 125 may outline costs for device payment plans or leases. Equipment charges 130 may encompass fees for additional equipment like SIM cards. Taxes and regulatory fees 135 show applicable taxes and government fees. Activation or upgrade fees 140 may detail one-time charges for new service lines or device upgrades. Late payment fees 145 may indicate charges due to delayed bill payment. Miscellaneous charges 150 may capture various other service-related fees. Discounts and credits 155 may show bill reductions from promotions or credits. Account summary 160 may provide an overview of total charges, payments, and final amount due. Account information 165 may contain additional details like the account number and customer service contact information. A person of skill in the art will appreciate that these sections are exemplary and relate to various categorizations of information within a bill but additional variations of the document are possible. Document 100 may be marked and organized for reference to understand in telecommunications service billing.

Service plan charges 105 may outline the base costs associated with the telecommunications service. This includes charges for talk time, text messages, and data usage as per the standard service agreement. This section may assist a user in understanding the basic or foundational cost of the service plan. This section may also include a plan name or identifier. users understand the foundational costs of their service plan. Service plan charges 105 may also include information which can identify the service agreement.

Usage charges 110 may include additional costs incurred by the user for exceeding the standard plan limits. These additional costs may be itemized. This information may include extra minutes, texts, or data usage over the plan's allowance, providing a clear indication of charges incurred due to excess usage. This information may also include the rate or basis of the charges which may also related to a base service plan that the user is part of.

Data usage 115 may display the amount of data consumed by the user, including any overage beyond the plans data limit. This section may be useful for users in monitoring their data consumption and understanding any additional charges due to data overage.

Roaming charges 120 may include services used outside the standard coverage area, such as international roaming. This section is useful for users who travel and use their mobile services outside their carrier's primary network. Additionally, if there are no roaming charges, the same information would become known through roaming charges 120.

Device payments 125 section outlines the costs associated with any device payment plans or leases that the user may have. This includes monthly installment payments for smartphones or other devices acquired through the carrier.

Equipment charges 130 may include fees for equipment related to the telecommunications service, such as SIM cards, mobile devices, protection plans, or accessory purchases. This section itemizes these extra charges that are considered to be outside a standard service plan.

Taxes and regulatory fees 135, all applicable government and regulatory charges are shown. This may include sales tax, 911 fees, and any other mandated charges, providing transparency in the billing process. This information may vary geographically and this information may be used in connection with a user's address to analyze whether these fees are correct and to the extent that they may be minimized.

Activation or upgrade fees 140 may detail any one-time charges incurred by the user for activating a new line or upgrading their device. These fees may be specific to certain transactions or changes in the service plan.

Late payment behaviors and their consequences may be captured in the late payment fees 145 section. This includes any additional charges or interest applied due to delayed payment of the bill, emphasizing the importance of timely payments. This information may be useful in analyzing customer behavior and credit score. Additionally, this information may be analyzed to present offers to the user which are more tailored to the user based on the user's payment behavior.

Miscellaneous charges 150 may encompass a variety of other fees or charges related to the service that do not fit into the standard categories. This could include charges for directory assistance, concierge services, insurance premiums for device protection plans, or other unique service-related fees.

Discounts and credits 155 section showcases any reductions applied to the bill, which may result from promotional offers, loyalty rewards, or other credits. This section highlights the opportunities where the user has saved money on their bill. This section may also include specific information related to a promotion or locked in rate which the user has been provided with, such as during a promotional period into which a user has been “grandfathered” in. As another example, a senior citizens discount may be illustrated here. These discounts and credits may be conditional or vary from a service provider to service provider.

Finally, the account summary 160 and account information 165 sections may provide an overarching view of the user's account. The summary offers a concise overview of the total charges, payments made, and the final amount due, while the account information section includes crucial details like the user's account number and contact information for customer service. These sections are essential for users to have a comprehensive understanding of their account status and billing details. These sections may include any other information such as overdue fees, one time credits, or current connectivity status.

Document 100 may also contain other information or fields in addition or complementary to those described above. For example, Document 100 may have the name of a service provider. The service provider may include a brand name behind a core service network. The service provider can be cross referenced with one or more live offers related to the service provider, internal databases, and other information obtained as inputs for one or more models described herein.

As further explained herein, the information contained in document 100 can be extracted analyzed for a variety of improvements. For instance, customer usage patterns, financial analysis, geographical and roaming data, customer loyalty and satisfaction indicators, regulatory compliance, service utilization trends, customer demographics and personalization, regional offers, legal and contractual obligations, and market research and competitive analysis can be obtained from document 100. As some non-limiting examples, information can be obtained or extracted from combining or analyzing the following types of information. A person of skill in the art will appreciate the analysis may vary or include additional combinations or sub-combinations. As another example, a person of skill in the art will appreciate that the examples shown are only examples and other information may be obtained.

| Example Category | Example Information | |
|---|---|---|
| of Analysis | From Document 100 | Example Use |
| Customer | Monthly Service | Analyzing call, |
| Usage Patterns | Plan Charges, | text, and data |
| | Usage Charges, | entries to |
| | Data Usage | identify usage |
| | | trends and habits |
| Financial | Device Payments, | Breaking |
| Analysis | Equipment | down and |
| | Charges, Taxes | categorizing |
| | and Fees, | financial entries |
| | Activation/Upgrade | for revenue |
| | Fees, Late | analysis and |
| | Payment Fees, | forecasting |
| | Miscellaneous | |
| | Charges | |
| Geographical | Roaming Charges | Assessing roaming |
| and Roaming | | entries to |
| Data | | understand |
| | | international and |
| | | out-of-network |
| | | usage patterns |
| Customer | Discounts and | Evaluating |
| Loyalty and | Credits, Late | discount and fee |
| Satisfaction | Payment Fees | patterns to |
| | | gauge customer |
| | | satisfaction and |
| | | loyalty levels |
| Regulatory | Taxes and | Ensuring all |
| Compliance | Regulatory Fees | tax and fee |
| | | entries align |
| | | with regulatory |
| | | standards; geographical |
| | | location; |
| | | upcoming rules. |
| Service Utilization | Entire Document | Assessment of |
| Trends | | all services |
| | | used to gauge |
| | | popular or |
| | | underused |
| | | services (e.g., |
| | | premium data, |
| | | 5G vs 4G |
| | | service, hotspot data). |
| Customer | Account | Creating customer |
| Demographics | Information, Usage | profiles based on |
| and Personalization | Patterns | usage and account |
| | | data for personalized |
| | | services |
| Billing | Detailed | Utilizing itemized |
| Accuracy and | Breakdown of All | charges for |
| Dispute Resolution | Charges | clarity in billing |
| | | inquiries and |
| | | disputes |
| Market | Comparative | Analyzing |
| Research and | Analysis with | billing structure |
| Competitive | Competitor Bills | against |
| Analysis | | competitors for |
| | | market insights |
| Legal and | Comparison | Verifying that |
| Contractual | with Service | all charges and |
| Obligations | Agreements | services align with |
| | | contractual obligations. |
| Fraud Analysis | Examine Potential | Verify that the document |
| | Fraud from | belongs to the purported |
| | Document Upload | potential customer or user; |
| | | examine address and name |
| | | for match; examine whether |
| | | phone number matches |
| | | name on document |
| | | from public or |
| | | other sources. |

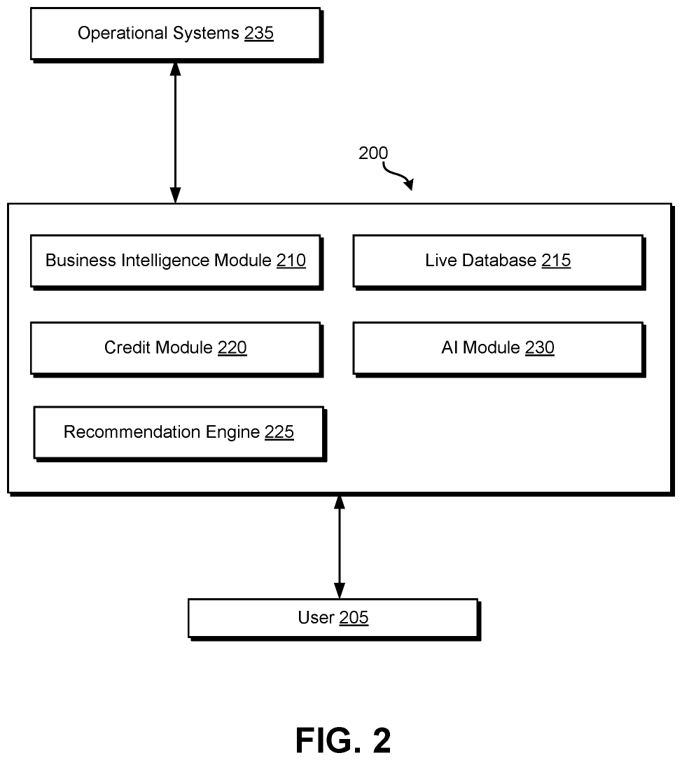

Other information may be included or obtained from the user in addition to information which can be obtained from document 100. For example, desired equipment (e.g., a specific phone), manufacturers, desired services (e.g., Netflix™, AppleCare™, Microsoft Office™) may be obtained or provided. Additional information which may be obtained or extracted can include an account number, phone number, name, address, number of lines, zip code, type of plan, carrier name, monthly bill totals, VAS, phone model, phone type, phone year, customers identity, and type of account. As further discussed below with respect to FIG. 2, information can be used to generate a new user profile which can be updated and used to provide tailored and customized recommendations to a user who desires to update or switch his or her wireless service. The new user profile may also be updated based on other information obtained from the user which may not be available or included in document 100. Other information can be included to create a user profile. Device-level details can be used to add to the user profile, and can include model and make information, operating system version, device settings, and patterns of app usage which may be obtainable from the device. The user device's IP address may also be used, including the number of times the IP address has attempted to switch, internet usage patterns, and geographic location. Additionally, user opted-in or browser-specific data, including aspects such as browsing history and cookie data, may be used when provided users have consented to share this information. As one example, this data, including geographic information derived from IP addresses and zip codes, may be used to create hyper-local targeted offers (e.g., within a specific city, zip code, or even more granular area).

In some examples, a form or other interface may be prepopulated with data gathered from a wireless bill or internal database with all fields which may be required to streamline an account creatoin process for a user. Verification of a user's identity may also be used to determine whether the customer has an account at any of the properties under a specific company or related companies. This may also allow for an account creation process to be streamlined if a customer already has an account at the specific service provider or associated service provider.

In some examples, the document 100 may be used to inform whether a balance is owed on any of the existing wireless devices or other equipment related with an existing user account, and whether the equipment is in a locked/unlocked or active/inactive state. In some examples this information may be used in customizing or tailoring offers for a user (e.g, buying the device out, trading the device in, or providing a new device). In some examples, knowing a customer device type from document 100 (or from other sources as described herein), it may be known whether or not the device type is eSIM compatible, and if an eSIM card switching may be performed. This information may be combined with other information to provide lock/unlock status to inform eligibility for offers such as a free trial, a second SIM card on the same device (e.g., in devices which support multiple physical SIMs, eSIMs, or a combination of the same).

FIG. 2. illustrates system 200. System 200 may be used to generate or tailor offers to users. Illustrated in FIG. 2 is system 200, user 205, business intelligence database 210, live database 215, credit database 220, recommendation engine 225, artificial intelligence systems 230, and operational systems 235. System 200 may be implemented on a computer system including a combination of computers, servers, and virtual machines. System 200 may be part of a digital operator platform (DOP). A digital operations platform (DOP) may be a connected data and process management tool that connects people, databases, users, and backend systems. System 200 may be used to analyze information from document 100. System 200 may also provide a user 205 with a notification if document 100 is missing or requires more information.

User 205 may access and interact with system 200 through a website, an application, an upload link, SMS, MMS, or other communication method through the internet or other communication system. The interaction may occur through a user device, mobile application, cell phone, mobile kiosk, tablet, or device. System 200 may also provide an offer or additional information to user 205 responsive to a user request or other input. For example, system 200 may receive document 100 from user 205 which can be analyzed by one or more modules within system 200. System 200 may parse document 100 for analysis. System 200 may also provide recommendations to user 205 and allow user 205 to initiate acceptance of a recommendation or offer. The acceptance of the recommendation or offer may initiate a process at operations systems 235 through which a user may enroll with a new service provider. In some examples, the SMS or MMS communication may be a series of questions and text messages which arrive from system 200 allowing the user to take his or her time in making the switch and not lose his or her progress in such a process.

Business intelligence module 210 can include one or more algorithms, software, and methods to analyze information in connection with generating offers for a user. Business intelligence module 210 may include a data repository which can aggregate, organize, and analyze publicly available market and industry standard information relevant to telecommunication services or other services. The database may collect information related to industry trends, market analysis, consumer behavior insights, or pricing strategies. Business intelligence module 210 may contain one or more modules to process data and extract data from publicly available sources and store that information. In this manner, business intelligence module 210 may obtain information about other carriers, available services, rates, plans, and offers, in order to analyze a user's bill and provide recommendations. Business intelligence module 210 may also contain additional capabilities to perform time series analysis, historical costs of a plan, “rate lock” guarantees, expiry of promotional credits, or other aspects related to a monthly, yearly, or aggregate cost of a service over a time period. In other examples, business intelligence module 210 may include the capability of generating a request information which cannot be obtained from the bill. In some examples, a request may include a list of questions to ask the user (e.g., when information cannot be clearly read or obtained from document 100) or when additional documentation is required about the document. In some examples, the business intelligence module 210 can further provide predictive abilities in conjunction with one or other modules. For example, the business intelligence module 210 may predict a market value for existing device equipment which may be later traded in or be incorporated as part of a promotion in the future. Business intelligence module 210 may thus provide this information to user 205 as part of what user 205 may desire as part of his or her monthly plan. As one example, if a user has a preference for Android™ devices (e.g., a Samsung™ device), a plan which provides discounted devices as part of the plan may also include the value of those devices. This information can be obtained from document 100 as well. In other examples, if user 205 brings his or her own device, that information may also be used by business intelligence module 210 or other modules.

Live database 215 may be a dynamic component which is updated periodically and may aggregate and update real-time data from various public sources (e.g., the internet, social media accounts, and news feeds). The database may thus ensure that the most recent information is available. In addition, live database may allow for updates in a service provider's plan or terms of service to be incorporated into system 200 for more complete analysis. In some examples, live database 215 may operate in conjunction with business intelligence module 210 to ensure that variations or updates to terms of service, promotional credits, codes, or “one-time offers” are all accounted for.

Credit module 220 may be a module which can relate to a user's creditworthiness for one or more offers. In some examples, credit module 220 may be used to determine which offers from a plurality of offers a user may qualify for. In some examples, a “soft” credit check may be used to determine the user's creditworthiness, based on information extracted from information 100. In other examples, a more comprehensive credit check can be used. In some examples, credit module 220 may provide additional information or recommendations to allow a user to qualify for a particular offer, such as a down payment amount on a particular device or equipment. In other examples, credit module 220 may provide a maximum amount of credit for a user (e.g., the purchase price of a device) or a length over which the device may be financed to quality (e.g., a maximum of $30 a month over 24 months or $60 a month over 12 months).

Credit module 220 may also contain additional modules which may be used to verify a user's identity to further facilitate the process of identifying offers, confirming identify, and validating offers. For instance, it can incorporate identity verification tools that cross-reference information from sources like utility bills. In some embodiments, credit module 220 may look at historical data relate to a user's previous bills, such as document 100, to look at a specific payment history related to the user for a specific service (e.g., home internet, cellular service). In such embodiments, credit module 220 may be able to suggest that a user is able to be provided with a specific service despite other information related to user 205's credit which may be negative. In some examples, the credit module 220 may also provide additional details which relate to fraud analysis. Credit module 220 may be able to consider the user's name, address, phone number, credit history, and other details useful to verify the user's identity to examine whether an authorized individual is attempting to open or switch an account by another user. In some examples, the credit module 220 may use a credit history in attempting to verify the user or performing fraud analysis prior to presenting offers. In some examples, fraud analysis may include requesting additional information from a user to confirm one or more details about a user.

In some examples, document 100 or similar documents (e.g., a series of previous bills) may include information which can add to the analysis of credit module 220. If a user's soft credit check or hard credit check indicates that the user does not qualify for a particular offer, but has a history of payments for a particular type of device or service (e.g., a flagship device, a certain data plan), this information may be reviewed internally by a human or through algorithmic process to determine a risk metric, and quality a user for a device, plan, or other service which he or she would otherwise not qualify for based only on a credit check.

Recommendation engine 225 may provide one or more recommendations to a user based on currently available plans which are tailored to a user's specific needs and preferences. Utilizing data included in business intelligence module 210 and live database 215, along with any user-provided information, recommendation engine 225 can employ one or more algorithms to analyze usage patterns, financial capabilities, and preferred services. It may cross reference such example factors against a comprehensive list of available plans to identify options that best match a profile of user 205. In this manner, recommendation engine 225 may provide recommendations which are useful not only in terms of service features, additional services, and “bundles,” but also align with a user's budget and creditworthiness. Thus, user 205 is able to more efficiently make a determination of whether or not to switch services. In some embodiments, the recommendation engine 225 can parse historical data from a user's prior use history of his or her service when additional information is available (e.g., multiple documents over an extended time period, such as several months) to make a recommendation of a “base service” for a user and add-ons to complement and tailor the experience to user 205 based on that experience.

As an example embodiment of a recommendation generated by recommendation engine 225, a user who generally does not use 5G data but travels once a year overseas for business purposes may be able to use a plan which is cheaper through a lower monthly data cap but includes a travel pass add-on for use when traveling abroad. Recommendation engine 225 can thus estimate and provide recommendations which are suitable based to user 205 based on that information.

Artificial intelligence (AI) module 230 may also be optionally used in system 200 to enhance a user experience or provide additional capabilities in personalizing user interactions and customizing user offers. Artificial intelligence module 230 may use artificial intelligence and machine learning algorithms to further provide more granular customization options by system 230. AI Module 230 may utilize machine learning algorithms to analyze and interpret user data and preferences. This data includes but is not limited to, user behavior patterns, service preferences, and historical information by user 205. For example, if a user consistently exceeds their data plan, AI Module 230 can intelligently suggest an alternative plan that better aligns with their usage patterns. AI module 230 may further simulate various scenarios for a user based on historic information that was obtained or gleaned from prior documents or bills to provide a more robust analysis to the user if required or desired by the user. AI module 230 can also use generative techniques to produce one or more visual aids for users to make informed decisions regarding their various options.

AI module 230 may also include capabilities to enhance user interaction when signing up for an offer. For example, AI module 230 may include natural language processing (NLP) to understand and response to a user. It may also include generative AI techniques to respond to a user's questions or queries about an offer, or to further assist with enhancing or tailoring plans for a user. The AI module may also provide additional information related to the plan, such as the quality of service, priority data, add-ons, or other benefits (e.g., phone insurance, no interest payment plans for equipment, trial offers).

AI Module 230 can incorporate a variety of algorithms. These may include, without limitation, deep learning, reinforcement learning for refining recommendations based on user feedback, and decision trees and random forests for decision-making processes. The use of neural networks may allow AI module 230 to process and analyze sequential data and images effectively.

Through the use of the various modules system 200 may interact with user 205, and allow user 205 to evaluate one or more offers, and enroll in at least one of the one of the one or more offers.

Operational systems 235 can include other systems and modules which are part of the service provider. These systems can allow a user account to be created upon a user accepting an offer and switching from an existing service provider to a new service provider. For example, if a user receives an offer and accepts that offer, operational systems 235 may initiate a process to enroll and switch the user to the new service provider or new service at the same service provider. In some examples, upon acceptance, user 205 may receive an indication that user 205 has initiated a switching process and when he or she is expected to receive the change.

System 200 may also obtain additional information from the user, such as an IMEI, port-out pin, or aspect to determine network compatibility with the user device and potential number port-out options. User 205 may also be provided additional updates from operations systems 235 or system 200 such as a tracing number for his or her device or SIM card. Thus, user 205 may be provided with a seamless porting experience. One or more of the modules in system 200 may also determine the process of porting over a phone number or other user account to the service provider. For example, if an existing device is capable of a virtual SIM or eSIM, the process may be done automatically or semi-automatically.

If a physical SIM is required, the process may move forward through shipping user 205 a new SIM card or welcome kit to obtain access to the new service provider.

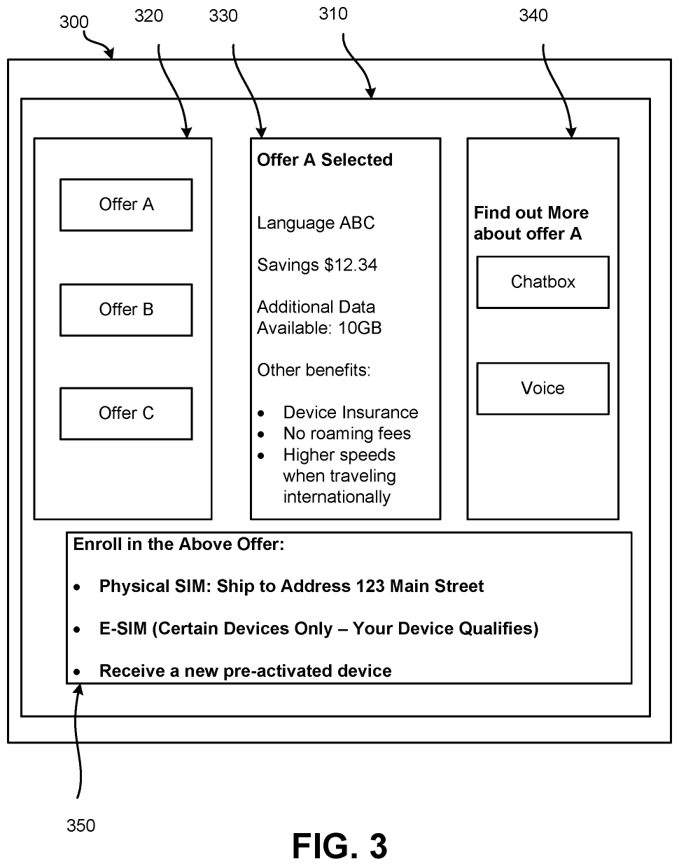

FIG. 3 illustrates an offer interface 310 which may be displayed on a user device 300. The user device 300, encompassing a range of devices such as mobile phones, laptops, and tablets, may be capable of receiving and processing input from a user, such as user 205. The offer interface 310 is a composite of various elements, including one or more offers 320, visualizations 330, an interaction interface 340, and an acceptance interface 350. These components collectively provide a comprehensive and interactive experience for the user in reviewing and understanding the offers presented.

The offer or offers 320 within the offer interface 310 may be crafted to align closely with the user's current service, ensuring relevance and appeal. In addition, these offers can include comparative elements, highlighting how they are superior or more advantageous compared to the user's existing service plan. This comparison is based in part on initial information provided or obtained by the user (e.g., document 100 or other user input), ensuring that the offer is tailored to their specific needs and circumstances. Furthermore, the system can generate conditional offers, such as those applicable when a user is porting in from a different carrier or has additional memberships which provide discounts. These offers are explained in a plain language, making them easily understandable to the user. Offers 320 may also be capable of displaying additional information about the offers. In some examples, offers 320 may be provided in an XML or other digital format which allows user device 300 to parse through the information contained therein. The offer may be formatted based on information about the user, the region, language preferences, or device preferences. For example, if there is a family plan, bundles for streaming subscription may be highlighted to a user.

Generative AI may be used to generate offers 320, enhancing the user's interaction with the offer. It provides additional information about the offer, explaining in detail how it differs from or improves upon the user's current service. This AI-driven interaction can make the evaluation process more engaging and informative for the user. In some examples, generative AI may be used to create customized offers which may be displayed in two dimensional or three dimensional views, including videos, interactive 3D models, animated 2D images, or other interactive images. In some examples, a virtual agent (e.g., a lifelike human or avatar) can be used to provide the generated offer to the user. The user can interact with the virtual agent to obtain additional information about the generated offers.

Additional “views” or visualizations 330 are also a part of the offer interface 310. These visualizations can depict the savings or benefits associated with the offer, such as monthly savings or the cumulative value of the offer including equipment or additional services. The visualizations may also be personalized based on demographic data related to the user, such as age, travel habits, business or personal use preferences, mobile hotspot or tethering usage, and roaming data. This customization ensures that the user receives a comprehensive understanding of the offer's value, tailored to their unique situation. In some examples, the visualizations or views may be based on user preferences stored within user device 300. For instance, user device may contain information indicating a level of complexity desired by the user of user device 300.

Interaction interface 340 allows for more information about a particular offer to be provided. Interaction interface 340 may allow for various interactions by the user to be performed, such as through a chatbox or a voice assistant. In some embodiments, these interactions can be powered through artificial intelligence or other mechanisms. Additionally, if a user requires assistance with enrolling in an offer, interaction interface 340 may be configured to allow a human operator to assist the user. Interaction interface 340 may be used to obtain additional information about a particular offer, details about an offer, or additional information about the offer.

Acceptance interface 350 within the offer interface 310 facilitates the enrollment process for the user. It may include options for accepting the offer, which can trigger various subsequent actions. For instance, in some scenarios, accepting an offer could lead to the shipping of a physical SIM card, pre-activated with the user's phone number. Alternatively, the offer could involve the porting of a phone number through eSIM activation. The acceptance interface 350 may be designed to be intuitive and user-friendly, ensuring a smooth transition for the user into the new service plan. This interface also allows for the input and verification of additional user-provided information, ensuring that all aspects of the offer and enrollment process are tailored to the user's needs and preferences. Illustrated in acceptance interface 350 are various enrollment options based on the user's device or offer information.

The various interfaces displayed may also update or change based on user interactions. For example, based on information from interaction interface 340, such as a co-signer or updated information about the user, the offers may change. Further, when a user is making a decision on a specific offer, interaction interface 340 may further change or allow a user to provide verification information or additional information.

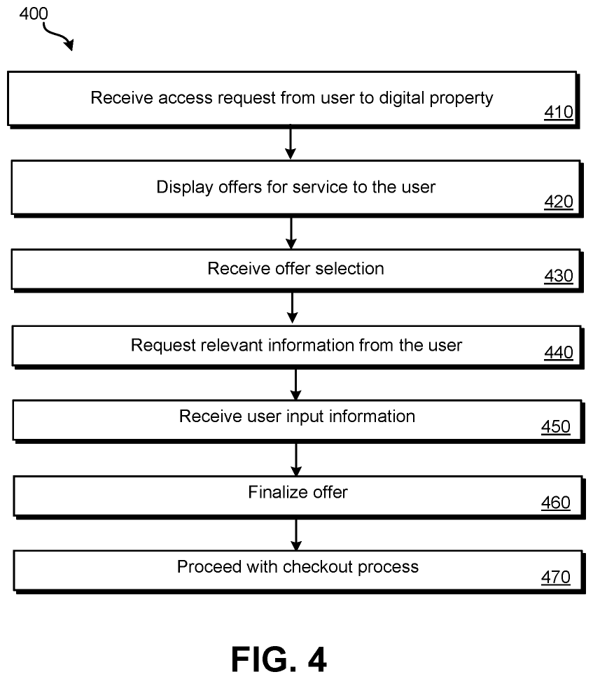

FIG. 4 illustrates a method 400 for signing up a new customer for a service.

At process block 410, an access request from a user at a digital property is received. In one embodiment, a digital property may be a website, a mobile app, a text message, a SMS, MMS, scan, kiosk, etc. In some examples, a digital property may facilitate receipt a document related to the user. For example, the document may be a document such as document 100 which contains information related to a current service plan and service provider of the user.

At process block 420, one or more offers are displayed to the user. The offers may be generated based on information analyzed from a document which may have been received at process block 410. In some examples, the offer may be displayed in an offer interface 310 discussed above with reference to FIG. 3. The displayed offers may be configured to include advantages of the offers over existing offers.

At process block 430, an offer selection is received. In some embodiments, the offer selection may be received through a user device 300 or through an acceptance interface 350. The offer selection may include basic information about the offer such as the offer identifier. At this block, the offer may be accepted by the user.

At process block 440, information is requested from the user. In one embodiment, the information may include the user's name, address, phone number, last four digits of their social security number, and/or a full social security number. In some examples, this information may be tokenized to allow the information to be transmitted to the system. In some examples, this information may be obtained through other digital alternatives, such as a digital token, a digital identity, a blockchain based digital identifier, or other source of user information.

At process block 450, the user information is received and an offer is generated based on the received information. At this block, additional information may be obtained from the user such as preferences for specific devices or features.

At process block 460, an offer may be finalized. This process may include the use of system 200 to ensure that the offer is suitable for the user and that the user qualifies to enroll in the offer. At process block 460, additional checks can be performed to ensure that the user qualifies for any conditional offers (e.g., the use of their own device, bundles, or a senior citizen discount). At this block, if any mandatory fields were not available or unavailable during a document upload process, additional information may be requested from the user at this process block.

At process block 470, the user continues to the checkout process. The checkout process may include providing financial and billing details, signing any legal documents or contracts to enroll in the service. Additionally, any consents, financing, or payment methods for the user can be displayed at this block. In some embodiments, this block may continue with the assistance of a human operator who may interact with the user. In some examples, existing integrations with financial providers or other accounts the user may be used to provide a deposit or periodic payment authorization in connection with the offer. Example accounts may include ApplePay™, Venmo™, Paypal™, SamsungPay™, and GooglePay™. This information may be useful when a certain deposit amount may be required to deposit money to qualify for a certain device or service.

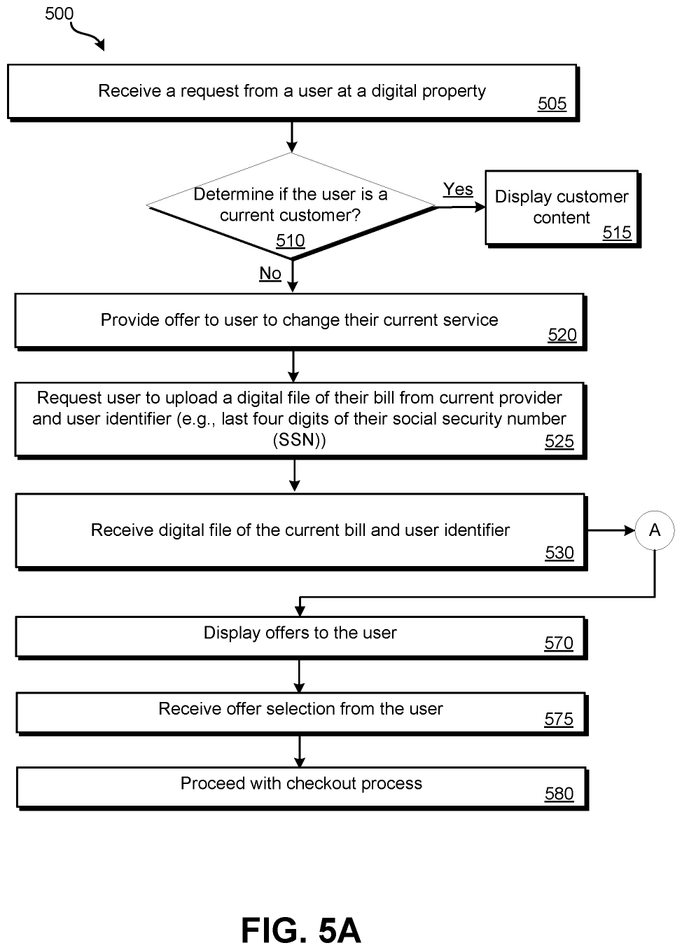

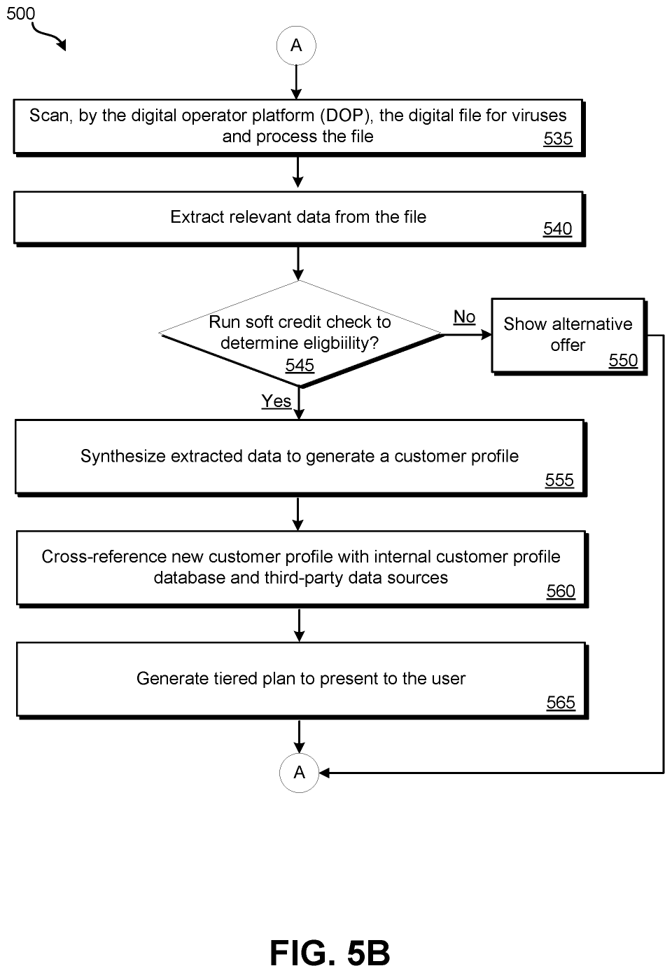

FIG. 5A illustrates a method 500 for signing up a new customer for a service in accordance with embodiments of the disclosure. At process 505, a request is received from a user for new service at a digital property. At decision block 510, a determination is made whether the user is a current customer. If it is determined that the user is a current customer, then customer content is displayed (process block 515). Otherwise, at process block 520, an offer to change service is provided to the user.

At process block 525, the user is requested to upload a digital file of their bill from their current provider. In one embodiment, the digital file may be a PDF, image file (i.e., a JPG, GIF, BMP, etc.) or a screenshot from the user's phone or PC. The user is also requested to provide the last four digits of their social security number (SSN). In some examples, a digital file may be similar to document 100.

Process continues to ‘A’ in FIG. 5B. At process block 535, the DOP may scan the digital file to determine if the file contains one or more viruses. Furthermore, the digital file is processed in order to extract relevant data (process block 540). In one embodiment the relevant data may include account number, phone number, user's name, address, zip code, current plan type, current carrier name, monthly bill total, VAS, phone module, phone type, and phone year.

At process block 545, a soft credit check may be run to determine the user's eligibility for service. If the user's credit score is below a predetermined threshold, then at process block 550, alternative offers may be shown to the user. In one embodiment, the alternative offer may be a prepaid or pay-as-you-go offer.

If the user's credit score exceeds the predetermined threshold, then at process block 555, the extracted data is synthesized to generate a customer profile. At process block 560, the new customer profile is cross-referenced against an internal customer profile database and other third-party sources. At process bock 265, a tiered plan is presented to the user.

The process continues back to point ‘A’ in FIG. 5A. At process block 570, the offers are displayed to the user. The user may then select the offer they want to purchase (process block 575). Them at process block 580, the user may proceed to the checkout process.

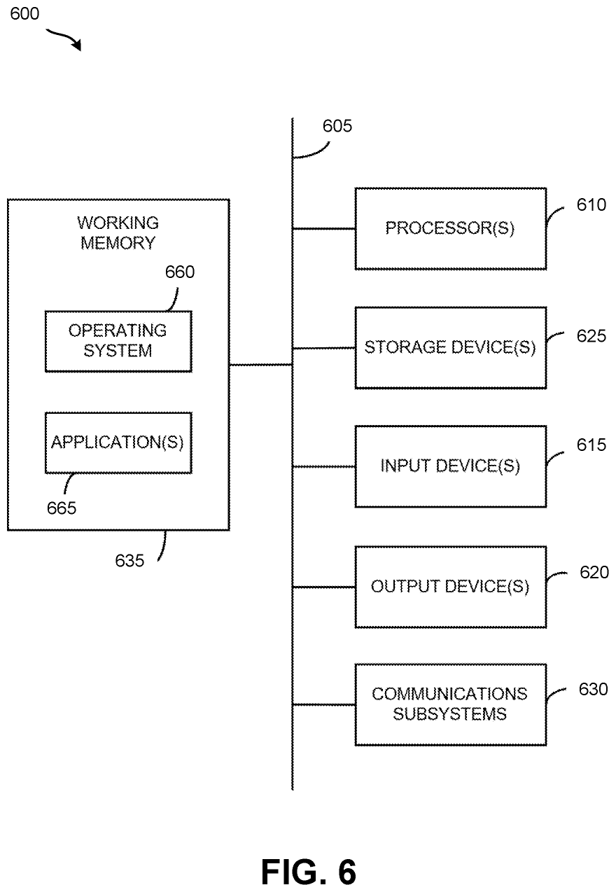

FIG. 6 is a schematic diagram illustrating an example of computer system 600. The computer system 600 is a simplified computer system that can be used to implement various embodiments described and illustrated herein. A computer system 600 as illustrated in FIG. 6 may be incorporated into devices such as a portable electronic device, mobile phone, or other device as described herein. FIG. 6 provides a schematic illustration of one embodiment of a computer system 600 that can perform some or all of the steps of the methods and workflows provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. The computer system 600 is shown including hardware elements that can be electrically coupled via a bus 605, or may otherwise be in communication, as appropriate. The hardware elements may include one or more processors 610, including without limitation one or more general-purpose processors and/or one or more special-purpose processors such as digital signal processing chips, graphics acceleration processors, and/or the like; one or more input devices 615, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 625, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 660, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g., the first electronic device, may be incorporated into the computer system 600, e.g., an electronic device as an input device 615. In some embodiments, the computer system 600 will further include a working memory 635, which can include a RAM or ROM device, as described above.

The computer system 600 also can include software elements, shown as being currently located within the working memory 635, including an operating system 660, device drivers, executable libraries, and/or other code, such as one or more application programs 665, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the operations of such methods are performed by the computer system 600 in response to processor 610 executing one or more sequences of one or more instructions, which might be incorporated into the operating system 660 and/or other code, such as an application program 665, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A computer-implemented method comprising:
receiving a request from a user at a digital property;
determining, by digital operator platform (DOP), that the user is a new customer;
requesting, from the DOP, upload of a digital file of the user's current bill and a user identifier;
receiving, at the DOP, the digital file and a user identifier provided by the user;
extracting data from the digital file;
generating a customer profile based on at least the extracted data and the user identifier, the customer profile containing information to analyze potential offers for a user;
based on the customer profile, generating at least one offer to the user for new service;
sending, by the DOP, at least one offer to the user; and
receiving an offer selection from the user and in response proceeding to checkout for the user.

2. The method according to claim 1, wherein the digital property includes one or more of the following: a website, a mobile app, and a kiosk.

3. The method according to claim 1, wherein the digital file of the user's current bill is a file type of one or more of the following: an XML file, a PDF, a screenshot, and an image file.

4. The method according to claim 1, further comprising:
scanning the digital file for viruses; and
determining that the digital file is free of viruses.

5. The method according to claim 4, further comprising:
determining that the digital file has one or more viruses; and
in response, displaying an error message to the user.

6. The method according to claim 1, further comprising in response to receiving the user identifier, running a credit check of the user.

7. The method according to claim 6, further comprising in response to the user's credit score being below a threshold, altering the at least one offer.

8. The method according to claim 1, wherein the user identifier is one of: a driver's license, a social security number, a passport, a national identification number, driver's license number, tax identification number, or digital credential.

9. The method according to claim 1, wherein the extracted data includes one or more of the following: account number, phone number, user's name, address, zip code, current plan type, current carrier name, monthly bill total, VAS, phone module, phone type, and phone year.

10. The method according to claim 1, further comprising performing a fraud analysis related to the user.

11. The method according to claim 10, further comprising:
provisioning a user account in response to passing the fraud analysis related to the user, the provisioned user account based at least in part on the at least one offer selected by the user.

12. The method according to claim 11, further comprising:
preparing activation of the provisioned user account based on key inputs from the user.

13. The method according to claim 12, wherein the key inputs are one of a user agreement, smart contract, or electronic contract.

14. The method according to claim 1, further comprising:
cross-referencing the customer profile with an internal customer profile database to determine if the user is an existing customer; and
if the user is an existing customer, notifying the user.

15. The method according to claim 1, further comprising:
obtaining device specific information, IP address, or location specific information related to the user; and
generating a localized offer based on the device specific or location specific information.

16. The method of claim 1 wherein the at least one offer is generated using generative artificial intelligence.

17. The method of claim 1 wherein the at least one offer may be interacted with by the user prior to offer selection.

18. A client device utilized in conjunction with a server and a communications network enabling communication between the client device and the server, the device comprising:
a processor; and
a computer-readable storage media storing computer-executable code that, when executed by the processor, causes the client media device to:
receive a request from a user at a digital property;
determine, by digital operator platform (DOP), that the user is a new customer;
request, from the DOP, upload digital file of the user's current bill and the user's last four digits of their social security number (SSN);
receive, at the DOP, the digital file and a user identifier provided by the user;
extract data from the digital file;
receive, at the DOP, the digital file and last four digits of the SSN;
generate a customer profile based on at least the extracted data and the user identifier, the customer profile containing information to analyze potential offers for a user;
based on the customer profile, generate at least one offer to the user for new service;
send the at least one offer to the user; and
receive an offer selection from the user and in response proceeding to checkout for the user.

19. A digital operator platform configured to facilitate user offers and user enrollment, the digital operator platform comprising:
a communication interface, configured to facilitate interaction between the digital operator platform and a user device, enabling receipt of a billing document and delivery of generated service offers to a user;
a processing module, the processing module configured to analyze the billing document received from a user device and generate a customer profile;
a recommendation engine within the digital operator platform to generate service offers based on the generated customer profile;
an artificial intelligence module coupled with the recommendation engine configured to enhance the generated service offers; and
a verification module configured to verify the accuracy of information contained in the billing document and to confirm an identity of the user.

20. The system of claim 19 wherein the digital operator platform is configured to enroll the user in a selected offer from the generated service offers and initialize the selected service offer.
